(19) United States
(12) Patent Application Publication
(10) Pub. No.: US 2012/0017711 A1
(43) Pub. Date: Jan. 26, 2012

(54) Counter rotation mechanism for lift and suspend loads devices

(76) Inventor: Samuel Gueller, (US)

(21) Appl. No.: 12/804,430

(22) Filed: Jul. 22, 2010

(51) Int. Cl. F16H 57/00; F16H 57/02

(52) U.S. Cl. 74/412 R

(57) ABSTRACT

A mechanical attachment to devices to dynamically lift and suspend loads, powered by the main shaft of the device, with the purpose to generate forces to cancel those that tend to rotate the device when the platform is not able to keep the system motionless, by means of a gear box and optional variable arm's length for counter rotation. The counter rotation equal the forces generated under rotation by the operating device to secure a total system in equilibrium.

### FIELD OF THE INVENTION

The present invention relates generally to the field of aeronautics and astronautics. Applications are in all types of lift and suspend loads devices installed in aircraft or spacecraft.

### BACKGROUND OF THE INVENTION

Devices that has powered single rotation means tend to rotate itself in the same direction that the rotating mass of that means when the capacity of the foundation is not able to restrain the movement of the enclosure of the whole system. One of such devices is the one to dynamically lift and suspend loads. It was found that up to certain low capacity such devices can be restrained by simple bases, like a table, while higher capacity devices need a foundation to the ground, and those of medium or high capacity lacking the ground foundation, like aircraft or spacecraft, need some means to cancel the undesirable rotation while in operation. Thus, there is an actual need to accomplish this goal.

### SUMMARY OF THE INVENTION

A mechanical gear box fixed to the ceiling of the enclosure or the floor, or both, of a lift and suspends loads system, coupled to the main powered shaft that invert the direction of rotation and transmit such counter rotation to the enclosure through the said box.

### BRIEF DESCRIPTION OF THE DRAWINGS

FIG. 1 is a diagram in cross section of the gear box

FIG. 2 is a simplified cross section view of and enclosed device FIG. 3 is a lateral view of a device, where the open gear box is installed by the ceiling of the enclosure. This device allows hanging weights.

FIG. 4 is a lateral view of a device, where the open gear box is installed by the floor of the enclosure. This device allows weights to be carry in a flat bed.

FIG. 5 shows two printouts of software for design analysis

FIG. 6 is a typical graph for design analysis

### DETAILED DESCRIPTION OF THE DRAWINGS

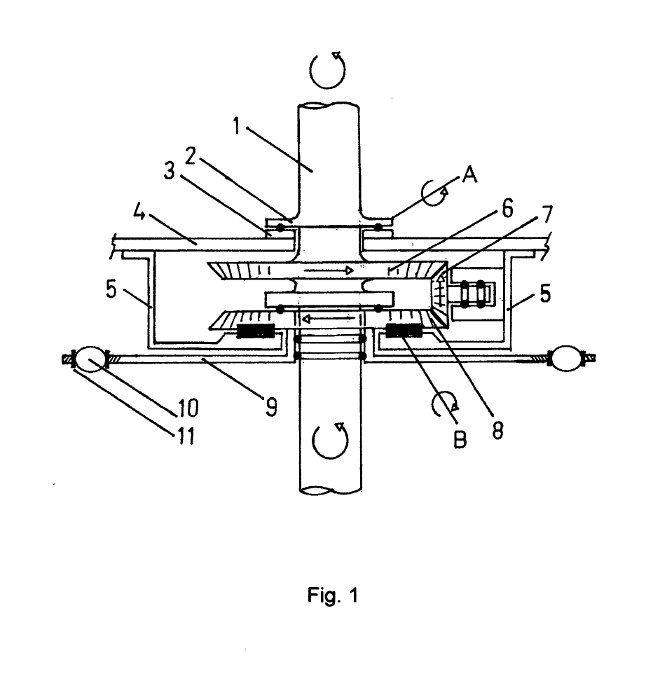

FIG. 1 In this diagram of a typical attachment numbers identifies the following parts:
1 Main powered shaft
2 Half shaft bearing
3 Half enclosure bearing
4 Enclosure
5 Gear box
6 Shaft-fixed conic gear
7 Coupling conic gear
8 Arm-fixed conic gear
9 Arm
10 Weight
11 Threaded sector of arm
A Counterclockwise rotation to enclosure
B Clockwise rotation thru gear box to enclosure

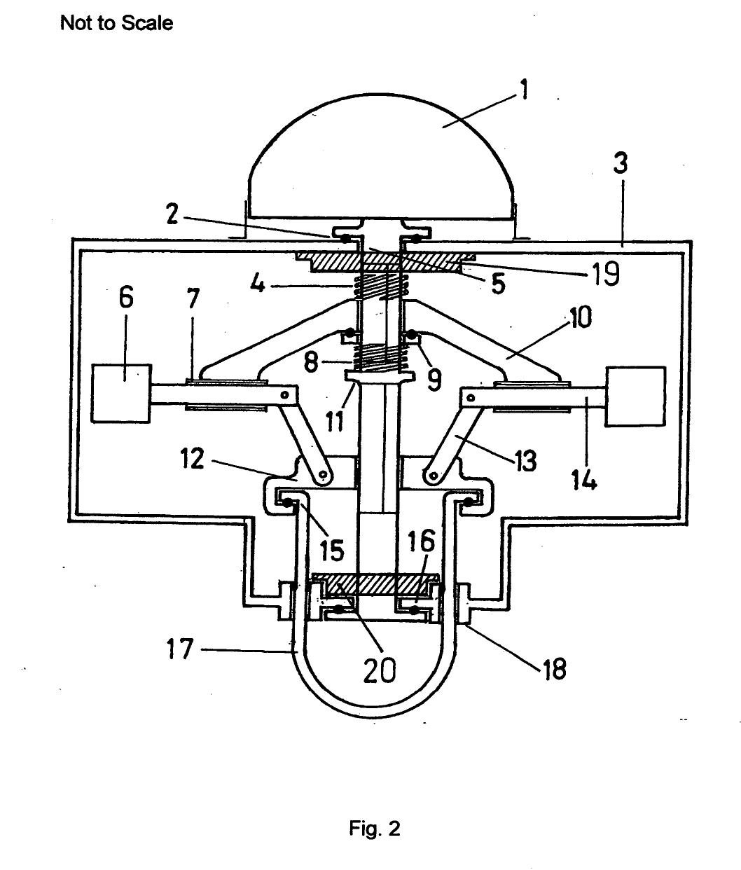

The main powered shaft must have new contours for adaptation of the gear box as required. The ceiling bearing of the main shaft exists per construction of the device, probably without modifications or modified per each particular detailed design of the device. The box contains a simple system of two equal or unequal diameters conic gears to change direction of rotation, and a conic gear coupling both. As in the device itself, two or more auxiliary arms have a weight at some distance of the center of rotation to help calibrate the energy of the counter system to cancel the undesired rotation of the device enclosure. That calibration includes different friction coefficient for ball bearing A and roller bearing B, different diameter of conic gears in the gear box, and different arm's length. The arms length is adjusted by moving the weight along its length and fixing them in its final positions. Bearings A located at the ceiling and floor of the enclosure, and bearing 15 in FIG. 2, exert the rotation force of the enclosure, Bearing B must counteract all for a null balance of forces.

FIG. 2 In this diagram of a device to lift and suspend loads with the attachment locations, numbers identify the following parts:
1 Cover of the power source, like engine of internal combustion
2 Upper bearing
3 Enclosure
4 Cushion string
5 Motorized shaft
6 Acting weights
7 Guide of displacing arms
8 Help spring
9 Easing bearing ring
10 Structural diagonals
11 Shaft's seat
12 Arms' joint
13 Connectors
14 Arms
15 Hanger's bearing
16 Lower bearing
17 Hanger
18 Hanger's guide
19 Attachment located at the ceiling of the enclosure
20 Alternative second attachment located at the floor of the attachment

A detailed description of this drawing can be seen in Pub. No. US 2009/0129912 A1, Pub. Date: May 21, 2009.

Parts 19 and 20 show locations where the gear box(es) must be located.

FIG. 3 is a diagram in cross section of a device, where the open gear box is installed by the ceiling of the enclosure with a variant of the gears configuration. This diagram serves as graphic information only.

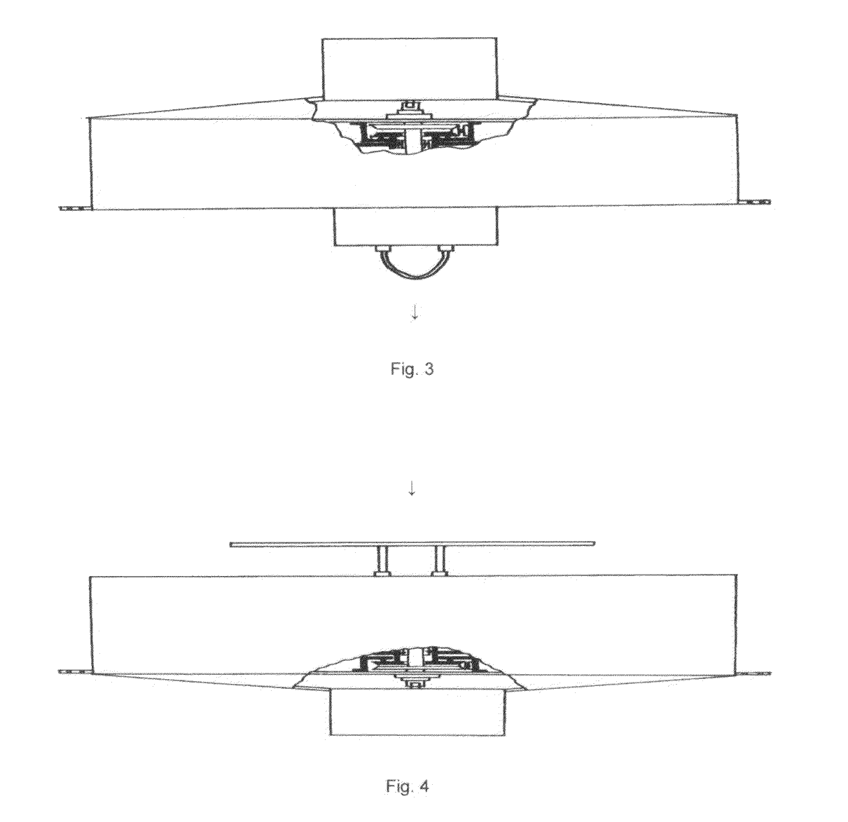

FIG. 4 is a diagram in cross section of a device, where the open gear box is installed by the floor of the enclosure where the device itself is properly installed upside down by adapting its internal elements to allow the use of a flat bed as load's carrying. This diagram serves as graphic information only.

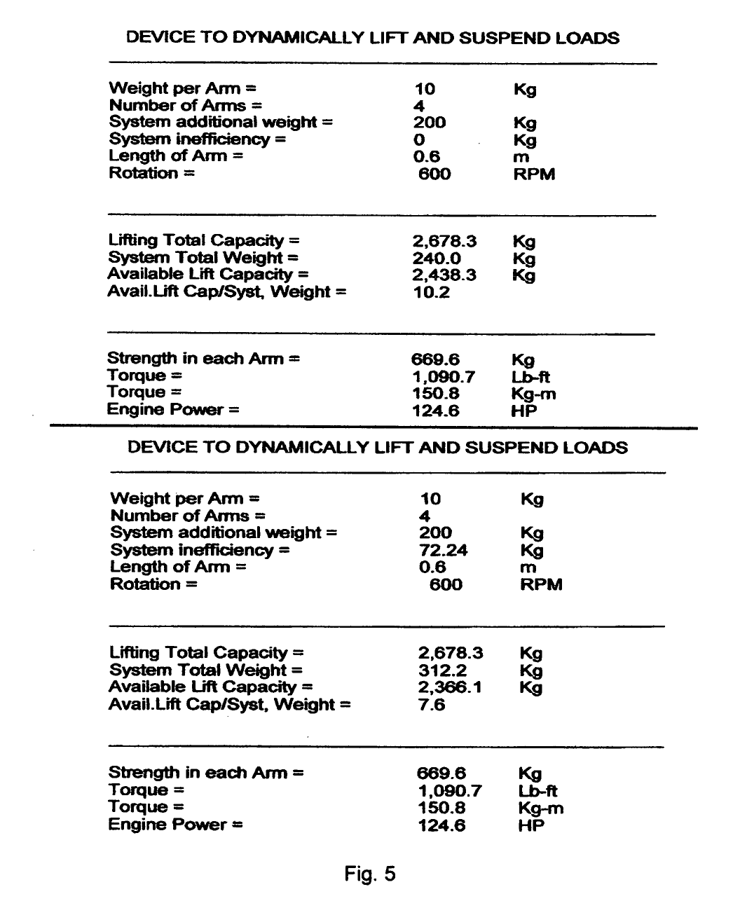

FIG. 5 shows two printouts of software for design analysis

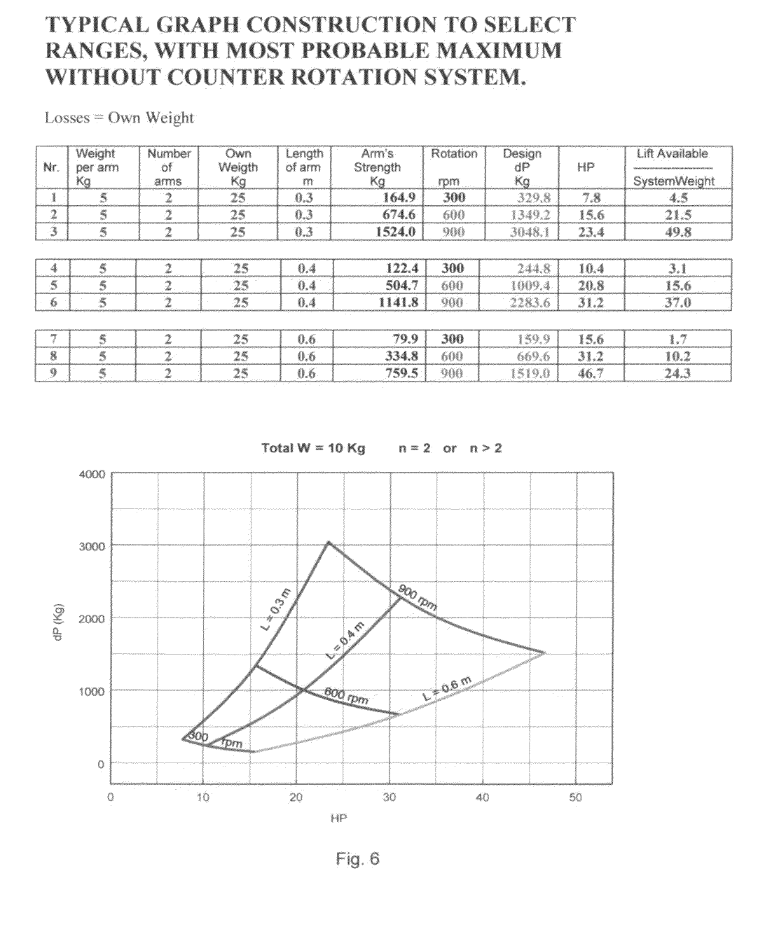

FIG. 6 shows how to build a type of graph for design analysis, the example shown is in the limits of device capacity that can be building without counter rotation and no foundation to the ground, smaller of this maximum size could be carry in aircrafts or spacecrafts, in particular at less than 300 rpm.

### DETAILED DESCRIPTION OF THE INVENTION

This attachment is activated by the rotating powered shaft 1 of the device. The shaft 1 rest on a bearing here decomposed in two parts 2 and 3. Another equivalent bearing 16 in FIG. 2 is located at the floor of the enclosure to keep it vertically stable.

The enclosure 4 belongs to the structure of the device. The gear box case 5 is fixed to the enclosure. The assembly of gears in the gear box consists of a horizontal conic gear 6 solidly fixed to the shaft 1, a vertical conic intermediate gear 7 with its own bearing fixed to the gear box wall, and a horizontal conic gear 8 not connected but separated from the shaft 1 free to counter rotate. Appended to this gear, optional arms 9 moving perpendicular to the shaft 1, carrying moving equal weights 10 which can be moved along the arm's length and adjusted in a convenient position by nuts 11 or other means. The arms of the device rotates at increasing circular motion until a proper rpm is reached to suspend the loads, its work differs from the arms of this attachment which provide no mechanical work but contribute with a inertial force in the balancing equalization of the rotation-counter rotation process.

In FIG. 1 bearing A push the enclosure to rotate and bearing B bring a contrary action. The friction coefficient of B is always larger than the friction coefficient A and it account for the counter rotation strength. The counter push action includes also the contribution of other parts of the internal elements of the device, mostly bearing 15 in FIG. 2. For safety reason the guide for vertical displacement 18 in FIG. 2 is needed even if this attachment for counter-rotating system is attached to the device.

The net suspended capacity dP for weight reduction was calculated from physics as

$$dP ( Kg ) = n * W ( 0.0001132 \frac{{RPM}^{2}}{L} - 1 )$$

where W (Kg)=weight at end of one arm; n=number of arms; L (meter)=length of arm; and RPM=revolutions per minute.

The power required for the dP capacity is:

P(HP)₁=0.008653*RPM*n*W*L

We can add an estimate of additional power required for the counter rotation system considering rotation force at bearing 15 in FIG. 2, this is significant, by similarity. All other forces that contribute to rotations need testing data. The similarity can be made considering the energy required by a moving vehicle on a bridge, where the dynamic load on the bridge is obtained by acceptable computations. With such approach, the bearing 15 in FIG. 2 is similar to the vehicle's wheels but it is motionless and the bearing flat bed is moving, contrary to the situation in the bridge. With the best formula for vehicles, an estimate can be made for the required power as:

P(HP)₂=0.00014*RPM*n*W

conversion to dP units (Kg) can be made by the relation:

Losses(Kg)=(P(HP)₂/P(HP)₁)*dP

Losses (Kg) are to be subtracted from the dP computed without losses, and P(HP)₁ will remain the same but the Available Lifting Capacity will be reduced.

FIG. 5 show in the first run

Losses(Kg)=(P(HP)₂/P(HP)₁)*dP=(0.00014*600*4*10/124.6)*2,438.3=(3.36/124.6)*2,438.3=0.0269663*2,678.3=72.2 Kg

where the losses (inefficiency) is zero. In the second run we introduce losses (inefficiency) as 72.2 Kg to obtain: Same Engine Power (124.6 HP), but now the Available Lift Capacity is reduced by the same amount (2,438.3 Kg−2,366.1 Kg=72.2 Kg.

The total P(HP)_{T}=P(HP)₁+P(HP)₂ is subject to check by operating a prototype and measure the input required.

Thus there has been described an attachment to a device to dynamically suspend loads as a mean to counter the effect of rotation if it appears when the device is operating. While the invention has been described in conjunction with specific embodiments thereof, it is evident that many alterations, modifications, and variations will be apparent to those skilled in the art in light of the foregoing description. Accordingly, it is intended to embrace all such alterations, modifications and variations in the appended claims.

What is claimed is:

1) A mechanical assembly as attachment comprising:
a gear box fixed to the enclosure of a lift and suspend device
a combination of gears inside the box powered by the main shaft of the said device two or more optional arms connected to the counter rotating gear inside the gear box moving weights adjustable along the length's arms.

2) The mechanical attachments of claim 1, wherein an alternative combination of gears is assembled in the gear box.

3) The mechanical attachment of claim 2, wherein the gear box is attached to the ceiling and floor of the device's enclosure.

4) The mechanical attachments of claim 3, further including alternative means to adjust the moving weights along the arms.

5) The mechanical attachments of claim 5, further including electric and/or electronic means to automatically control moving elements to reach a pre-determined point of equilibrium between rotation and counter rotation.

6) The mechanical attachments of claim 1, without the optional arms and adjusted weights.

7) Application of this attachment to other than lifts and suspends loads devices as applicable to aeronautics and astronautics fields.
